(19) United States
(12) Patent Application Publication
(10) Pub. No.: US 2004/0064745 A1
(43) Pub. Date: Apr. 1, 2004

(54) Method and apparatus for controlling the rate at which instructions are executed by a microprocessor system

(76) Inventor: Sudarshan Kadambi, Hayward, CA (US)

Correspondence Address: PARK, VAUGHAN & FLEMING LLP, 508 SECOND STREET, SUITE 201, DAVIS, CA, 95616, US

(21) Appl. No.: 10/259,720

(22) Filed: Sep. 26, 2002

(51) Int. Cl. G06F 1/26; G06F 1/28; G06F 1/30

(52) U.S. Cl. 713/322

(57) ABSTRACT

One embodiment of the present invention provides a system that facilitates controlling the rate at which instructions are executed by a microprocessor. The system starts by receiving a signal indicating the existence of a throttling condition. In response to the throttling condition, the system reduces the rate at which instructions are executed by the microprocessor. In a variation on this embodiment, the throttling condition can include a processor idle state, a processor overheating state, or a power over-consumption state.

### FIELD OF THE INVENTION

The present invention relates to the design of microprocessor systems. More specifically, the present invention relates to a method and an apparatus for controlling the rate at which instructions are executed within a microprocessor system.

### RELATED ART

Over the past thirty years, the processing power of microprocessor systems has doubled virtually every 18 months. Each successive generation of microprocessors has more transistors than its predecessor, and these transistors are packed closer together on the microprocessor chip. These advances have enabled microprocessor clock speeds to increase at an exponential rate. Unfortunately, this trend, which shows no signs of abating in the foreseeable future, is creating new problems.

As clock speeds continue to increase, microprocessor systems consume larger amounts of power, and as a result, generate larger amounts of heat. In many computer systems, enormous heat sinks and fans are presently being used to help cool the microprocessor chip. The cooling problem is becoming further compounded as larger numbers of processors are integrated into a single computer system. Some computer systems use liquid cooling to remove heat from microprocessor chips. However, liquid cooling systems greatly increase the complexity and cost of computer systems and can create additional reliability problems.

Many microprocessor systems contain internal temperature sensors that cause them to shut down when they reach a maximum operating temperature to avoid damage. While this protects the physical hardware from damage, the computer system typically will not function properly until a safe temperature is reached.

Along with excessive heat generation, power consumption is also a growing concern. A server with multiple processors can consume many kilowatts of power, even when it is idle. As energy costs continue to rise, excessive energy consumption can waste a great deal of money. Note that computer systems continue to consume power and generate heat even during idle states when they are not performing any useful work. Much of this power consumption and heat generation during idle states is largely wasted.

Hence, what is needed is a method and an apparatus for reducing the amount of unnecessary power consumption within microprocessor systems without the problems mentioned above.

### SUMMARY

One embodiment of the present invention provides a system that facilitates controlling the rate at which instructions are executed by a microprocessor. The system starts by receiving a signal indicating the existence of a throttling condition. In response to the throttling condition, the system reduces the rate at which instructions are executed by the microprocessor.

In a variation on this embodiment, prior to performing the throttling, the system determines a rate at which instructions are to be executed by the microprocessor during the existence of the throttling condition.

In a variation on this embodiment, the signal indicating the existence of the throttling condition is received from a service processor.

In a variation on this embodiment, the signal indicating the existence of the throttling condition is received from an operating system.

In a variation on this embodiment, the signal indicating the existence of the throttling condition is received from a sensor on the microprocessor. In a further variation, the sensor on the microprocessor detects the temperature of the microprocessor.

In a variation on this embodiment, reducing the rate at which instructions are executed by the microprocessor involves modifying an instruction dispatch policy so that the number of instructions being dispatched per clock cycle is less than the number of functional units within the microprocessor that are able to receive an instruction in a given clock cycle.

In a variation on this embodiment, reducing the rate at which instructions are executed by the microprocessor involves waiting a pre-determined number of clock cycles between each successive instruction fetch operation.

In a variation on this embodiment, reducing the rate at which instructions are executed by the microprocessor involves reducing the internal clock frequency of the microprocessor.

In a variation on this embodiment, the throttling condition can include a processor idle state, a processor overheating state, or a power over-consumption state.

### BRIEF DESCRIPTION OF THE FIGURES

FIG. 1 illustrates a computer system in accordance with an embodiment of the present invention.

FIG. 2 illustrates the process of issuing instructions in a microprocessor in accordance with an embodiment of the present invention.

FIG. 3 illustrates an implementation of a throttle mask in accordance with an embodiment of the present invention.

FIG. 4 presents a flowchart illustrating the process of throttling a microprocessor in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

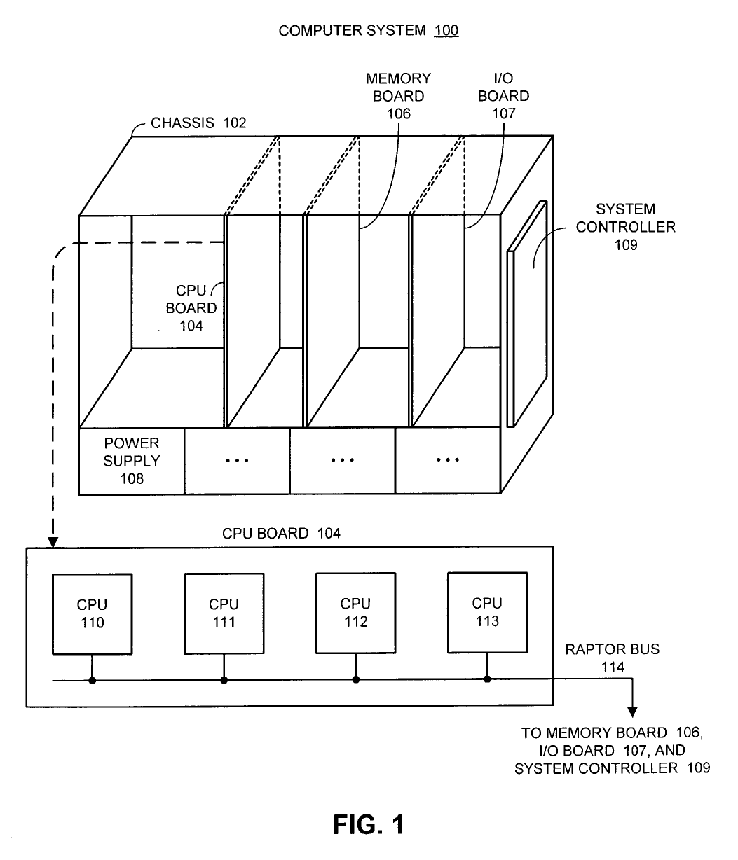

FIG. 1 illustrates a computer system 100 in accordance with an embodiment of the present invention. Computer system 100 can generally include any type of computer system, including, but not limited to, a computer system based on a microprocessor, a mainframe computer, a digital signal processor, a portable computing device, a personal organizer, a device controller, and a computational engine within an appliance. In the embodiment illustrated in FIG. 1, computer system 100 is a large enterprise computer system that includes multiple central processing units (CPUs).

As is illustrated in FIG. 1, computer system 100 includes a chassis 102 that includes at least one power supply 108, which converts AC power into DC power for use by circuitry within computer system 100. Chassis 102 is designed to house a number of boards containing processors, memory, and/or I/O devices. More specifically, chassis 102 can house one or more CPU boards, such as CPU board 104, which contain a number of CPU chips. Chassis 102 can also house one or more memory boards, such as memory board 106 an one or more I/O boards such as I/O board 107.

The CPU boards operate under control of system controller 109. System controller 109 monitors system state information such as processor idle state and operating temperatures, as well as controlling the system for fault-tolerance purposes.

In one embodiment of the present invention, computer system 100 includes two system controllers for fault-tolerance purposes. In this way, if one of the system controllers fails, the other can take over so that computer system 100 can continue to operate despite the failure.

CPU board 104 is illustrated in more detail in the bottom portion of FIG. 1. Note that CPU board 104 includes four CPU chips 110-113 which are coupled together via Raptor bus 114. Memory board 106, I/O board 107, system controller 109 are also coupled to Raptor bus 114.

Issuing Instructions in a Microprocessor

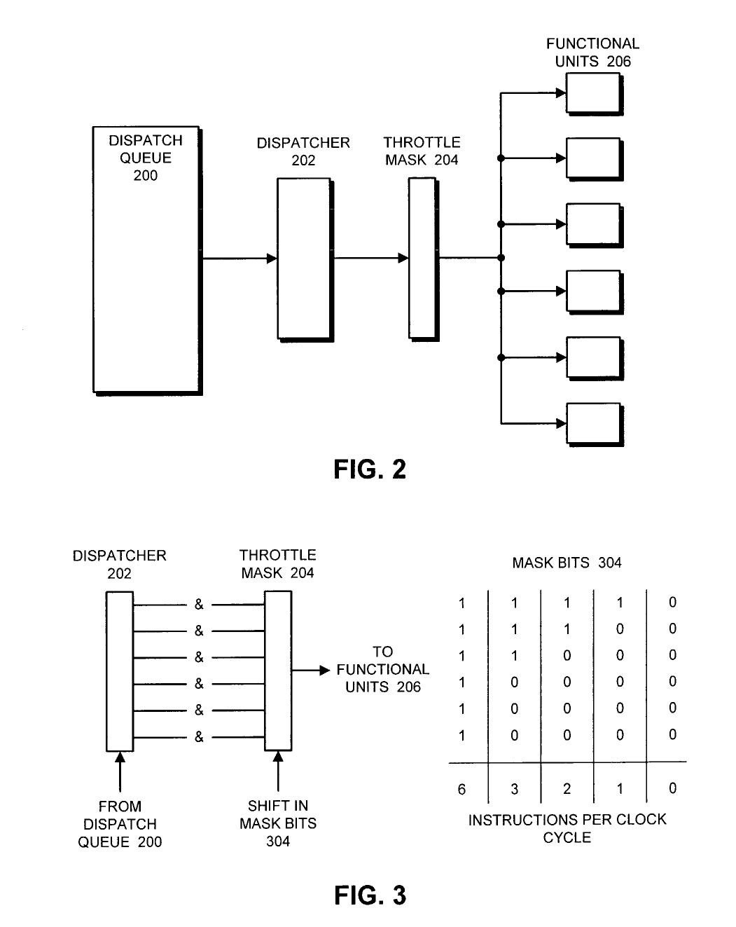

FIG. 2 illustrates the process of issuing instructions in a microprocessor in accordance with an embodiment of the present invention. A given CPU within computer system 100 contains dispatch queue 200, which is a queue containing instructions that are scheduled to execute. When all of the dependencies for execution have been satisfied, dispatcher 202 retrieves the instruction from dispatch queue 200 and dispatches it to one of the multiple functional units 206 through throttle mask 204. Throttle mask 204 is used to selectively control which functional unit instructions are sent to as is described below with reference to FIG. 3. In another embodiment, throttle mask is used to limit the number of instructions dispatched in any given clock cycle.

Implementation of a Throttle Mask

FIG. 3 illustrates how throttle mask 204 is used to control the rate at which instructions are issued in accordance with an embodiment of the present invention. Throttle mask 204 contains a number of mask bits 304 that are associated with functional units 206. Mask bits 304 control which functional units instructions can be issued to. In the case where mask bits 304 are all set to “1”, instructions can be sent to all six functional units. Hence, up to six instructions per clock cycle will be dispatched to functional units 206. At the other extreme, where all mask bits 304 are set to “0”, instructions cannot be sent to any of the functional units. In this case, zero instructions per clock cycle will be dispatched to functional units 206. During throttled operation, one to five of the mask bits 304 will be set, thereby allowing instructions to be sent to one to five functional units. In this way, the rate at which instructions are executed can be controlled to be anywhere from zero to six instructions per cycle.

Process of Throttling a Microprocessor

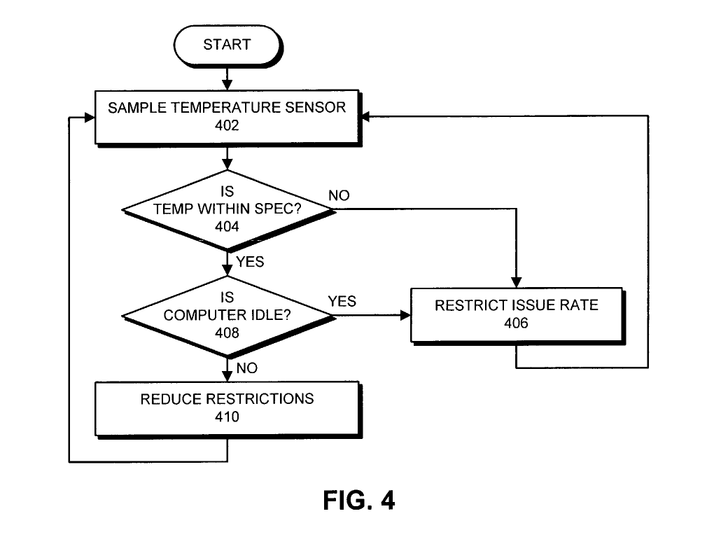

FIG. 4 presents a flowchart illustrating the process of throttling a microprocessor in accordance with an embodiment of the present invention. The system starts by sampling the temperature sensor inside of CPU 110 (step 402). From this sample, the system determines if the temperature is below a pre-specified threshold value for CPU 110 (step 404). If the temperature is above the threshold value, the system restricts the issue rate of instructions being dispatched to functional units 206 inside of CPU 110 via throttle mask 204 (step 406) and then returns to step 402. Restricting the issue rate in this way effectively reduces power consumption, and in turn, reduces the amount of heat being generated by CPU 110. Also note that CPU 110 can be throttled back to the point where no instructions are being issued, effectively shutting down CPU 110 for a limited number of clock cycles.

There are other ways to reduce power consumption besides using throttle mask 204 to limit instruction issuance. In another embodiment of the present invention, the system restricts the issue rate of instructions being dispatched to functional units 206 by waiting a pre-determined number of clock cycles between each fetch operation. In yet another embodiment, the system reduces the internal clock frequency of CPU 110.

If the temperature of CPU 110 is below the threshold value, the system determines if CPU 110 is idle (step 408). Note that this can be accomplished a number of ways. In one embodiment, system controller 109 notifies the system of CPU 110's idle state. In another embodiment, the system monitors the rate at which instructions are being retired by CPU 110. In yet another embodiment, the system is notified by the operating system that CPU 110 is idle. If CPU 110 is idle, the system also restricts the issue rate (step 406) and returns to step 402. On the other hand, if CPU 110 is not idle at step 408, the system reduces restrictions on the issue rate (step 410) and returns to step 402.

In another embodiment of the present invention, the system also throttles CPU 110 based on power consumption. When the power being consumed by computer system 100 exceeds a pre-determined value, the system throttles back the instructions being issued to functional units 206 in some or all of the CPUs inside of computer system 100.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for throttling a microprocessor comprising:
receiving a signal indicating the existence of a throttling condition; and
in response to the throttling condition, performing the throttling by reducing the rate at which instructions are executed by the microprocessor.

2. The method of claim 1, wherein prior to performing the throttling, the method further involves determining a rate at which instructions are to be executed by the microprocessor during the existence of the throttling condition.

3. The method of claim 1, wherein receiving the signal indicating the existence of the throttling condition further involves receiving the signal from a service processor.

4. The method of claim 1, wherein receiving the signal indicating the existence of the throttling condition further involves receiving the signal from an operating system.

5. The method of claim 1, wherein receiving the signal indicating the existence of the throttling condition further involves receiving the signal from a sensor on the microprocessor.

6. The method of claim 5, wherein the sensor on the microprocessor detects the temperature of the microprocessor.

7. The method of claim 1, wherein reducing the rate at which instructions are executed by the microprocessor further involves modifying an instruction dispatch policy so that the number of instructions being dispatched per clock cycle is less than the number of functional units within the microprocessor that are able to receive an instruction in a given clock cycle.

8. The method of claim 1, wherein reducing the rate at which instructions are executed by the microprocessor further involves waiting a predetermined number of clock cycles between each instruction fetch operation.

9. The method of claim 1, wherein reducing the rate at which instructions are executed by the microprocessor further involves reducing the internal clock frequency of the microprocessor.

10. The method of claim 1, wherein the throttling condition can include:
a processor idle state;
a processor overheating state; and
a power over-consumption state.

11. A computer-readable storage medium storing instructions that when executed by a computer cause the computer to perform a method for throttling a microprocessor comprising:
receiving a signal indicating the existence of a throttling condition; and
in response to the throttling condition, performing the throttling by reducing the rate at which instructions are executed by the microprocessor.

12. The computer-readable storage medium of claim 11, wherein prior to performing the throttling, the method further involves determining a rate at which instructions are to be executed by the microprocessor during the existence of the throttling condition.

13. The computer-readable storage medium of claim 11, wherein receiving the signal indicating the existence of the throttling condition further involves receiving the signal from a service processor.

14. The computer-readable storage medium of claim 11, wherein receiving the signal indicating the existence of the throttling condition further involves receiving the signal from an operating system.

15. The computer-readable storage medium of claim 11, wherein receiving the signal indicating the existence of the throttling condition further involves receiving the signal from a sensor on the microprocessor.

16. The computer-readable storage medium of claim 15, wherein the sensor on the microprocessor detects the temperature of the microprocessor.

17. The computer-readable storage medium of claim 11, wherein reducing the rate at which instructions are executed by the microprocessor further involves modifying an instruction dispatch policy so that the number of instructions being dispatched per clock cycle is less than the number of functional units within the microprocessor that are able to receive an instruction in a given clock cycle.

18. The computer-readable storage medium of claim 11, wherein reducing the rate at which instructions are executed by the microprocessor further involves waiting a pre-determined number of clock cycles between each instruction fetch operation.

19. The computer-readable storage medium of claim 11, wherein reducing the rate at which instructions are executed by the microprocessor further involves reducing the internal clock frequency of the microprocessor.

20. The computer-readable storage medium of claim 11, wherein the throttling condition can include:
a processor idle state;
a processor overheating state; and
a power over-consumption state.

21. An apparatus for throttling a microprocessor comprising:
a receiving mechanism configured to receive a signal indicating the existence of a throttling condition; and
a throttling mechanism configured to perform the throttling by reducing the rate at which instructions are executed by the microprocessor.

22. The apparatus of claim 21, further comprising a determination mechanism configured to determine a rate at which instructions are to be executed by the microprocessor during the existence of the throttling condition.

23. The apparatus of claim 21, wherein the receiving mechanism is additionally configured to receive the signal from a service processor.

24. The apparatus of claim 21, wherein the receiving mechanism is additionally configured to receive the signal from an operating system.

25. The apparatus of claim 21, wherein the receiving mechanism is additionally configured to receive the signal from a sensor on the microprocessor.

26. The apparatus of claim 25, wherein the sensor on the microprocessor detects the temperature of the microprocessor.

27. The apparatus of claim 21, wherein the throttling mechanism is additionally configured to modify an instruction dispatch policy so that the number of instructions being dispatched per clock cycle is less than the number of functional units within the microprocessor that are able to receive an instruction in a given clock cycle.

28. The apparatus of claim 21, wherein the throttling mechanism is additionally configured to wait a pre-determined number of clock cycles between each instruction fetch operation.

29. The apparatus of claim 21, the throttling mechanism is additionally configured to reduce the internal clock frequency of the microprocessor.

30. The apparatus of claim 21, wherein the throttling condition can include:
a processor idle state;
a processor overheating state; and
a power over-consumption state.
